(19) United States
(12) Patent Application Publication
(10) Pub. No.: US 2001/0037266 A1
(43) Pub. Date: Nov. 1, 2001

(54) UPC consumer product image server system for the internet

(76) Inventor: William D. Schroeder, Brown Deer, WI (US)

Correspondence Address: JOSEPH S. HEINO, KNUTSON & HEINO, S.C., 13105 W BLUEMOUND RD, STE 100, BROOKEFIELD, WI, 53005-8022, US

(21) Appl. No.: 09/813,664

(22) Filed: Mar. 21, 2001

Related U.S. Application Data
(60) Provisional application No. 60/193,338, filed on Mar. 30, 2000.

(51) Int. Cl. G06F 17/60

(52) U.S. Cl. 705/27; 709/203

(57) ABSTRACT

A UPC image server system includes at least one image file server, high-speed Internet access, and a plurality of images stored on the image file server. The plurality of image files are stored on the mass storage system of at least one image file server according to their UPC numbers and image size. The images are accessible by entering the domain of the image file server, the UPC number of the product, and the desired image size, all in a standardized format (a unique URL). The unique URL of the image on the image file server is written into the web page code or generated by software as required. When a customer desires to access an e-commerce web page, only the web page and proprietary images are sent from the e-commerce server. The consumer product images are downloaded from the UPC image file server system.

This Application claims the benefit of U.S. Provisional Application No. 60/193,338, filed Mar. 30, 2000.

### FIELD OF THE INVENTION

The present invention relates generally to the field of networked computer systems and consumer-oriented web sites available on the Internet. More particularly, it relates to an image server system for the Internet which allows product images to be more quickly and efficiently created, stored, distributed, maintained, located, transmitted and displayed to an Internet web page than that previously possible with prior art. It also relates to any number of systems or formats for assigning identification numbers to products or articles in the stream of commerce, including products which are assigned numbers under the Universal Product Code (“UPC”) system, the International Standard Book Numbering (“ISBN”) system, the European Article Numbering (“EAN”) system, the Japanese Article Numbering (“JAN”) system, and the International Standard Serial Numbering (“ISSN”) system, to name a few.

### BACKGROUND OF THE INVENTION

Presently, images of consumer products which are used in the promotion, advertising, coupons, catalogs, and on e-commerce web sites are individually acquired and customized from manufacturer's promotional images, or “product art work”. The promotional images are normally provided by the product's manufacturer to the numerous members of its distribution network. In the experience of this inventor, there is almost always some type of inconsistency between an image displayed on different web sites such as image size, crop, resolution or color adjustment. Further, there is the question of whether the image presented on any given web site accurately represents the most current version of a given product. This inconsistency between web sites may appear to the consuming public as somewhat unprofessional and confusing, to the point of possibly even discouraging consumers from purchasing a given product that appears in such fashion.

Web page developers are presently required to spend a large amount of time locating, scanning, cropping, adjusting, and sizing each and every consumer product image that is to be used on any given web site. If there is a change to the image or to the product itself, some web sites will be quicker than others to make the change, and some may never get around to making it.

Requesting and obtaining the numerous images which represent a complete product line from a manufacturer may take considerable time, simply because of the amount of work which is required to create and organize the artwork necessary for hundreds or even thousands of products. Alternatively, a dealer, distributor or web site creator can have usable images created by photographing the product or products themselves. This is, however, a costly and time-consuming activity.

Generally speaking, all web sites which are available on the Internet are accessed in accordance with a standard protocol or format. In order for a user to access a web site, the user must have a computer which is electronically connected to the Internet via an Internet Service Provider (“ISP”). The user must also have compatible software for communicating with the Internet protocols. This software enables the user to “browse” through the many sites which are available on the Internet. A user can access a specific web site by typing in the site's location (web address) as a Universal Resource Locator (“URL”). The web server, or “host,” transfers instructions for constructing and displaying a web page to the user's computer. The web site host of each e-commerce web site must have sufficient bandwidth on its Internet connection in order to handle the flow of instructions which are required to satisfy the demand for access to the web pages of any given web site, or “domain.” In addition, the Internet connection available to the host must also have the capacity to transmit the images that are related to the web pages and which are normally stored in image files on the host system. The web site server must also have a large amount of storage capacity, the purpose of which is to store thousands upon thousands of images in relatively large files.

In the view of this inventor, there is a clearly felt need in the art for a UPC image server system for the Internet which allows anyone to easily access a huge catalog of consumer product images in various sizes, to reduce programming time, increase overall throughput to users, reduce image acquisition costs, reduce maintenance costs, reduce bandwidth requirements for consumer web sites, and provide a manufacturer with control over their product images which appear on Internet web pages.

Although specifically referred to here as a UPC image server, it is to be understood that the term UPC is being used in the generic sense to represent any system or format for assigning identification numbers to products or articles in the stream of commerce.

Accordingly, it is an object of the present invention to provide a new and useful UPC image server method and system which is connected to the Internet and which may be strategically located at one specific location or, alternatively, at several or many physical locations throughout the world. It is a further object of the present invention to provide such a UPC image server method and system which decreases the storage capacity requirements of most e-commerce web servers. It is yet a further object of the present invention to provide such a UPC image server method and system which decreases the bandwidth requirements to the Internet of most e-commerce web sites. It is still a further object of the present invention to provide such a UPC image server method and system which decreases the time it takes for an image requested by an e-commerce web page to be fully acquired and displayed. It is yet a further object of the present invention to provide such a UPC image server method and system which decreases web page programming time. It is yet a further object of the present invention to provide such a UPC image server method and system which allows a manufacturer to provide consistent images to a distributor, retailer and/or consumer in a more timely, standardized and controlled manner. And it is still another object of the present invention to provide such a UPC image server method and system which functions in a highly efficient and reliable manner.

### SUMMARY OF THE INVENTION

The present invention has obtained these objects. It provides for a UPC image server method and system for use with the Internet which allows a manufacturer's created image files to be transferred from an image server having high-speed access to the Internet. The UPC image server method and system of the present invention includes at least one image file server, high-speed Internet access, and a plurality of product image files stored on the image file server. The high-speed Internet access provides a connection between the image file server and at least one “backbone” of the Internet. Internet backbones are located throughout the world and are interconnected via other backbones and connections. The high-speed Internet access is as close to being a direct connection to an Internet backbone as is practical at any given physical location. Alternatively, several, and even many, image file servers could have high-speed access to one or more backbones and may be strategically located within the Internet system. The many image files are stored on the mass storage systems of the image file server(s) in a scheme according to their UPC codes and image size, resulting in a standardize or “derived” URL. A manufacturer through standard FTP protocol, or a proprietary file transfer protocol, could easily upload the product image files to the image file server, with restricted ID/Password access to the manufacturer's directories. Any files updated in this manner would automatically be propagated across any and all servers within the system by file synchronization software. Routing and load balancing hardware and software would also be part of the system, as required.

The product images would be accessible by entering the domain name of the image file server, the UPC code of the product, and the desired image size, all in a specified format. This would be a “derived” and standardized URL to the product image, with knowledge of only the UPC number for that product. With the knowledge of the UPC number for a product, the derived URL of the desired product image, with a size selection, is written into the web page code, or generated as required by the software that is creating the page. This could be created, for example, as a database or catalog “search results” page or other dynamic page creation method. When a customer desires to access a consumer e-commerce web page, only the web page source and proprietary images are sent from the e-commerce server. The product images themselves are called in from the UPC image server system. The time for the product image to be sent to the user is reduced, because the image file server is likely to have access which is “virtually” closer to the client than the e-commerce server itself.

The foregoing and other features of the method and system of the present invention will become apparent from the detailed description which follows.

### BRIEF DESCRIPTION OF THE DRAWING

FIG. 1 is a block diagram of a UPC image server system, three e-commerce servers, and three client/users in accordance with the method and system of the present invention.

### DETAILED DESCRIPTION

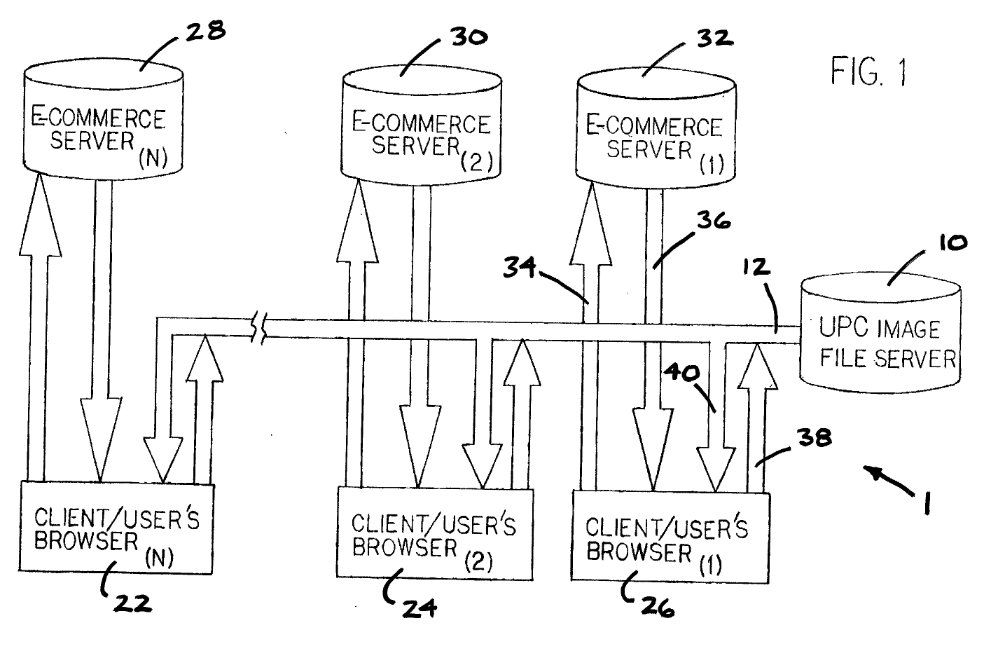

With reference now to the drawing, FIG. 1 shows a block diagram of a UPC image server system, generally identified 1, in accordance with the method and system of the present invention. More particularly, FIG. 1 shows the browsers 22, 24, 26 of one or more client/users, one or more e-commerce servers 28, 30, 32 and at least one UPC image file server 10.

Again, although specifically referred to here as a UPC image server 10, it is to be understood that the term UPC is being used in the generic sense to represent any system or format for assigning identification numbers to products or articles in the stream of commerce.

The UPC image server system 1 includes at least one image file server 10, high-speed Internet access 12, and a plurality of product images (not shown) stored on the image file server 10. The high-speed Internet access 12 provides the connection between the image file server 10 and the Internet.

The most important aspect of the UPC image server system 1 is whatever structure or combinations enable the invention to operate in a satisfactory and efficient manner is the preferred embodiment of the invention. The structure or combinations, which are the most satisfactory and efficient will likely change as Internet technology advances.

In the system and method of the present invention, a plurality of product images (not shown) are stored in a storage media of the image file server 10 according to the UPC and image size. The product images may be arranged within the storage media according to a hierarchy structure, database method, or any other suitable data/file structure and/or method. A manufacturer, through FTP protocol, may easily upload the product images to the image file server 10. The manufacturer would have to pass identification and password security to upload or alter a product image file. The identification and password prevent a manufacturer's product images from being tampered with.

One method of defining a unique URL for each product image is shown as follows:

src=http:H/www.server.com/mmmmmm/pppppp-ddd.jpg

where:

src is the web page programming property which specifies a URL.

server.com is a domain name of the image file server

mmmmmm is the manufacturer code portion of the UPC. The manufacturer code may vary in length, and further this number may be broken down into groups of 2 or 3 digits to create additional sub-directory breakdowns.

pppppp is the product code portion of the UPC. The product code may vary in length.

ddd is pixel width of the image requested.

jpg is the file extension of the product image file, although the “gif” file type could also be used within the system, and one or both could be designated as the standard(s).

Another method that may be preferred in certain operating system environments would be similar to the above but would farther reduce the number of files in each directory, and is shown as follows:

src=http://www.server.comlmmmmmm/pppppp/ddd.jpg

where:

src is the web page programming property which specifies a URL.

server.com is a domain name of the image file server

mmmmmm is the manufacturer code portion of the UPC. The manufacturer code may vary in length, and further this number may be broken down into groups of 2 or 3 digits to create additional sub-directory breakdowns.

pppppp is the product code portion of the UPC. The product code may vary in length.

ddd is pixel width of the image requested.

jpg is the file extension of the product image file, although the “gif” file type could also be used within the system, and one or both could be designated as the standard(s).

The product image may be downloaded or accessed by entering the URL of the image file server 10, the UPC number of the product image (in the appropriate format or syntax), and the desired image size. Preferable, standard product image widths would be specified, such as 50, 75, 100, 125, 150, 175, 200, 250, 300, 350, 400,450, 500, 550, and 600, all expressed as the image's width in displayed “pixels”.

When an end user, via its browser 22, 24, 26, desires to access an e-commerce web page containing consumer product images, only the web page is sent from the e-commerce server 28, 30, 32, respectively. The product images are called in from the image file server 10. The time for the product image to be called into the web page is probably reduced, because the image file server 10 is likely to be connected virtually closer to the client/user than the e-commerce server 28, 30, 32.

In application, a first client/user's browser 26 sends a URL request 34 to the first e-commerce server 32, defining a unique URL for each web page desired as previously discussed. The first e-commerce server 32 sends its file response 36 to the URL request 34 in the form of instructions to the browser 26 as to where it can find the images required by the web page. Receiving these instructions 36, the first client/user's browser 26, in turn, sends a second request 38 directly to the UPC image file server 10 based upon the instructions 36 the browser 26 has received. The image file server 10 responds by forwarding 40 an image file directly back to the browser 26, which downloads the image from the image file server 10. In similar fashion, a second client/user's browser 24 can download a web page from a second e-commerce server 30 and an infinite number of browsers 22 can download a web page from an infinite number of e-commerce servers 28. It is also to be understood that many such image file servers 10 can be dispersed throughout the system 1 so as to provide multiple access points and back-up capabilities for network portions which may from time to time prove to be incapable of reliable transmission of data and instructions. The strategic placement of many image file servers throughout the Internet will provide most users/clients with “virtual proximity” to an image file server.

In the view of this inventor, operating revenues for this method and system would likely be generated from the manufacturers in the form of a nominal monthly administration fees and a fee for each image that is stored on the UPC image server system 1. Anyone would be able to download, or otherwise access a product image without paying a cost or fee of any sort.

From the foregoing detailed description of the illustrative embodiment of the invention set forth herein, it will be apparent that there has been provided a new and useful UPC image server method and system which is connected to the Internet and which may be strategically located at one specific location or, alternatively, at several or many physical locations throughout the world; which decreases the storage capacity requirements of an e-commerce web server; which decreases the bandwidth requirements to the Internet of any given e-commerce web site; which decreases the time it takes for an image requested by an e-commerce web page to be fully acquired and displayed; which decreases web page programming time; which allows a manufacturer to provide consistent images to a distributor, retailer and/or consumer in a more timely, standardized and controlled manner; and which accomplishes all of this while functioning in a highly efficient and reliable manner.

The principles of this invention having been fully explained in connection with the foregoing, I hereby claim as my invention:

1. A method of increasing the efficiency by which images of consumer products are delivered to web pages on the Internet, comprising the steps of:
providing at least one image file server which is connected to the Internet;
uploading a plurality of images to said image file server;
storing each said image based on its related UPC number and an image size, thereby creating a unique URL for each said image; and
writing a web page containing syntax that calls in said unique URL of at least one image.

2. The method of increasing the efficiency by which images of consumer products are delivered to web pages on the Internet of claim 1 wherein each image has a plurality of selectable sizes.

3. The method of increasing the efficiency by which images of consumer products are delivered to web pages on the Internet of claim 2 wherein the product manufacturers who desire to place product images on said at least one image file server system being the parties that provide the revenue stream for operating said UPC image server system.

4. A method of increasing the efficiency by which images of consumer products are delivered to web pages on the Internet, such products being assigned an identification number in accordance with a numbering system, comprising the steps of:
providing at least one image file server which is connected to the Internet;
uploading at least one image to said image file server;
storing each said image based on its related identification number and an image size;
assigning a URL to said image based upon the identification number and image size, thereby creating a unique URL for each said image; and
writing a web page containing syntax that calls in said unique URL of said at least one image.

5. The method of increasing the efficiency by which images of consumer products are delivered to web pages on the Internet of claim 4 wherein said URL assigning step includes using the UPC (“Universal Product Code”) number, or portions thereof, to create the unique URL for the image of the product represented by said UPC number.

6. The method of increasing the efficiency by which images of consumer products are delivered to web pages on the Internet of claim 5 wherein each image has a plurality of selectable sizes.

7. The method of increasing the efficiency by which images of consumer products are delivered to web pages on the Internet of claim 6 wherein the product manufacturers who desire to place product images on said at least one image file server system being the parties that provide the revenue stream for operating said UPC image server system.

8. A method of increasing the efficiency by which images of consumer products are delivered to a browser from an image file server on the Internet, such products being assigned an identification number in accordance with a numbering system, comprising the steps of:
providing at least one image file server which is connected to the Internet;
uploading at least one image to said image file server;
storing each said image based on its related identification number and an image size;
assigning a URL to said image based upon the identification number and image size, thereby creating a unique URL for each said image;
sending a URL request to the e-commerce server from said browser;
sending a file response to the browser from said e-commerce server;
sending a request to the image file server from the browser in accordance with the file response received from said e-commerce server;
sending an image file from the image file server to the browser; and
displaying a web page containing the image file received from the image file server.

9. The method of increasing the efficiency by which images of consumer products are delivered to web pages on the Internet of claim 8 wherein said URL assigning step includes using the UPC (“Universal Product Code”) number, or portions thereof, to create the unique URL for the image of the product represented by said UPC number.

10. The method of increasing the efficiency by which images of consumer products are delivered to web pages on the Internet of claim 9 wherein each image has a plurality of selectable sizes.

11. The method of increasing the efficiency by which images of consumer products are delivered to web pages on the Internet of claim 10 wherein the product manufacturers who desire to place product images on said at least one image file server system being the parties that provide the revenue stream for operating said UPC image server system.

12. A UPC image server system comprising:
at least one image file server being connected to the Internet;
a plurality of images being stored on said image file server, each said image being defined by a UPC number and an image size;
a unique URL being assigned to each said image with said image size; and
at least one web page containing one said unique URL.

13. The UPC image server system of claim 12 wherein each image has a plurality of selectable sizes.

14. The UPC image server system of claim 13 wherein the product manufacturers who desire to place product images on said at least one image file server system being the parties that provide the revenue stream for operating said UPC image server system.
